(19) United States
(12) Patent Application Publication
(10) Pub. No.: US 2015/0238884 A1
(43) Pub. Date: Aug. 27, 2015

(54) Composite Filter Assembly and Method

(71) Applicant: Phong Vu, Houston, TX (US)

(72) Inventor: Phong Vu, Houston, TX (US)

(73) Assignee: DELTA SCREEN & FILTRATION, LLC, Houston, TX (US)

(21) Appl. No.: 14/623,387

(22) Filed: Feb. 16, 2015

Related U.S. Application Data
(60) Provisional application No. 61/945,632, filed on Feb. 27, 2014.

(51) Int. Cl. B01D 35/02

(52) U.S. Cl. CPC B01D 35/02

(57) ABSTRACT

Embodiments of a filter assembly for use in down-hole applications generally include a drain filter, an inner layer of filter media, an outer layer of filter media, and a cover filter. The inner filter media includes a woven filter media spiral wrapped around the drain filter, with adjoining edges abutting, and the outer filter media includes a woven filter media spiral wrapped around the inner filter media, with adjoining edges abutting. Abutting edges of the second filter media are offset from the first filter media abutting edges. Embodiments of a method of constructing a filter assembly for use in down-hole applications generally include providing a drain filter by a wire wrap process, wrapping an inner filter media around the drain filter, wrapping an outer filter media around the inner filter media layer, and providing a cover filter by a wire wrap process, wherein abutting filter media layer edges are offset.

### CROSS-REFERENCE TO RELATED APPLICATIONS

This application claims the benefit of U.S. Provisional Application No. 61/945,632 filed on Feb. 27, 2014, which application is incorporated herein by reference as if reproduced in full below.

### STATEMENT REGARDING FEDERALLY SPONSORED RESEARCH OR DEVELOPMENT

Not applicable.

### FIELD OF THE INVENTION

The present invention relates generally to systems and methods of controlling particulate intrusion in a perforated pipe in a well bore. More specifically, the present invention addresses a system and method of constructing a composite sand control screen.

### BACKGROUND

Down-hole drilling operations commonly require filter screens to restrain sand and particulates existing in the well environment from entering pipe openings.

In a commercially practiced process, wire is continuously wrapped helically onto a pipe structure with determined spacing between adjoining wire segments such that fluid flow between wire segments is allowed but sand and small particulates are screened.

To effectively screen fine particles, such as particles so small that slots between the wire in a screen produced by a wire-wrap processes do not provide desired filtering results, woven filter media may be utilized. Due to strength concerns, including potential damage to the screen resulting in screen openings, perforated shrouds are utilized to protect the filter media. See, e.g., U.S. Pat. No. 6,382,318 to Whitlock.

In a known process, sheets of preformed filter media are wrapped transversely around a pipe segment with overlapping edges. The filter media sheets are held in place by a perforated outer shroud having inward protrusions that are mechanically compressed against the filter media. See, e.g., U.S. Pat. No. 6,305,468 to Broome, et al.

In yet another process, a filter medium is cold-rolled with a perforated metal shroud and spiral-wound around a screen support to form a filter cartridge. In such application, adjoining edges of spirally-wound shroud segments are welded at the shroud seams. See U.S. Pat. No. 7,287,684 to Blackburne, Jr.

### BRIEF SUMMARY OF THE INVENTION

Embodiments of the present invention comprise a filter assembly for filtering fluids in a down-hole application, comprising a drain filter, an inner layer of filter media, an outer layer of filter media, and a cover filter; the drain filter comprising a spiral wrap, the inner filter media comprising a woven filter media spiral-wrapped around the drain filter with adjoining edges abutting, the outer filter media comprising a woven filter media spiral-wrapped around the inner filter media with adjoining edges abutting, the second filter media having abutting edges offset from the first filter media edges, and the cover filter comprising a spiral wire wrap.

An embodiment of a method of the present invention comprises providing a drain filter by a wire wrap process, wrapping an inner filter media around the drain filter, wrapping an outer filter media around the inner filter media layer, and providing a cover filter by a wire wrap process.

### BRIEF DESCRIPTION OF THE DRAWINGS

For a more complete understanding of the exemplary embodiments, reference is now made to the following Description of Exemplary Embodiments of the Invention, taken in conjunction with the accompanying drawings, in which:

FIG. 1 depicts a section view of a filter assembly of an embodiment of the present invention.

FIG. 2 depicts a perspective view image of a drain filter of an embodiment of the present invention.

FIG. 3 depicts a perspective view image of a filter assembly of an embodiment of the present invention attached to a pipe section.

FIG. 4 depicts a perspective view image of a cover filter of an embodiment of the present invention installed on an outer filter media.

FIG. 5 depicts a side view image of a cover filter of an embodiment of the present invention installed on an outer filter media.

FIG. 6 depicts a method of an embodiment of the present invention.

### DESCRIPTION OF EXEMPLARY EMBODIMENTS OF THE INVENTION

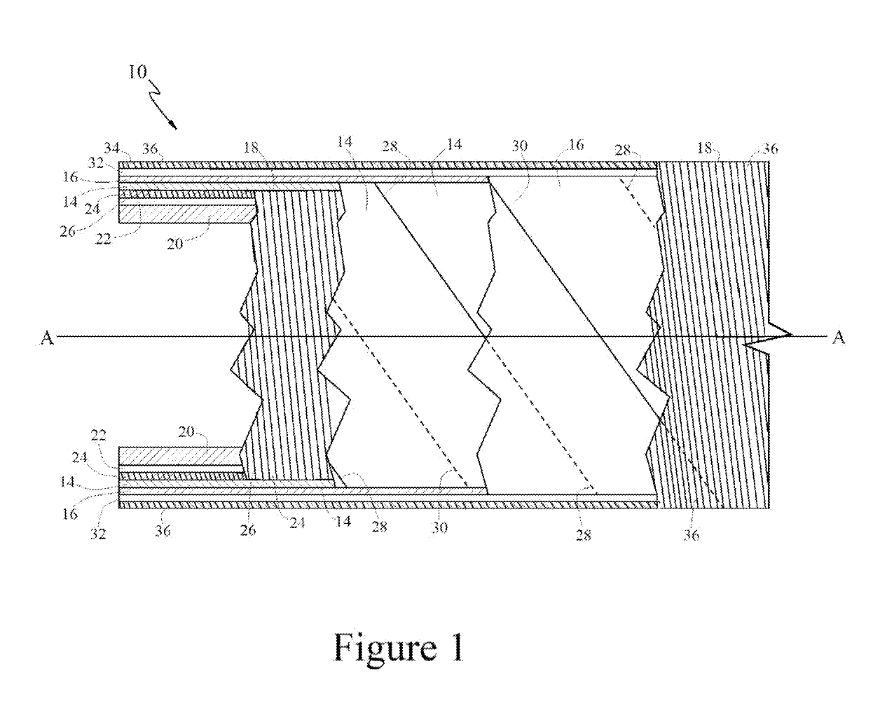

The exemplary embodiments are best understood by referring to the drawings with like numerals being used for like and corresponding parts of the various drawings. As used herein, longitudinal refers to the axis A-A identified in FIG. 1 and transverse refers to a direction normal to axis A-A of FIG. 1. As used herein, inner refers to a direction toward axis A-A and outer refers to a direction away from axis A-A.

Referring to FIG. 1, a cross-sectional view of an embodiment of a screen assembly 10 of the present invention is depicted. Screen assembly 10 comprises a drain filter 12, an inner filter 14, an outer filter 16, and a cover filter 18. Screen assembly 10 is depicted installed on a pipe 20. In an exemplary embodiment, pipe 20 is a perforated pipe structured for use in an oil or gas well to receive and transmit formation fluids.

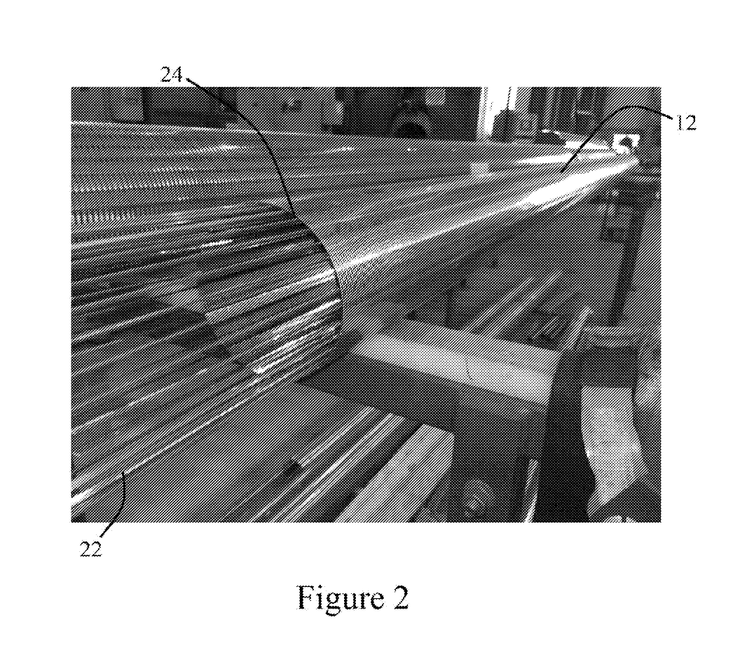

Referring to FIGS. 1 and 2, in one embodiment, drain filter 12 comprises a wire wrap filter constructed of ribs 22 and wire 24. In a process that is commercially practiced, drain filter 12 is constructed utilizing specially-constructed wire wrap machinery by extending ribs 22 longitudinally along an axis such as axis A-A, spirally wrapping wire 24 around the exterior of ribs 22, and welding wire 24 to ribs 22 at each intersection of wire 24 to a rib 22. Such process is controlled to provide a continuous slot 26 between proximate wire 24 edges. Within limitations, the width of the slot 26 opening can be controlled during the manufacturing process.

Referring to FIG. 1, inner filter 14 is depicted as installed and wrapped around the outer surface of drain filter 12. Inner filter 14 comprises a suitable filter medium, such as but not limited to, a wire mesh sized and constructed to provide openings sufficiently small to filter particulates contained in fluid flowing through the filter. In an exemplary embodiment, inner filter 14 comprises a woven wire mesh constructed in elongated, relatively narrow sheets. In an exemplary embodiment, inner filter wire mesh is installed from manufactured rolls of material having a length of in excess of 50 meters and having a diameter (width) of approximately 6″ (15.24 cm.). Inner filter 14 is spirally wound around drain filter 12 with an inner surface of inner filter 14 engaging exterior surfaces of wire 24 and with transverse edges of inner filter 14 abutting each other at seams 28. While inner filter 14 is presented in the embodiment depicted in FIG. 1 as comprising a single layer of a filter medium, in additional embodiments, inner filter 14 may comprise a plurality of layers comprising the same or different filter media.

Still referring to FIG. 1, outer filter 16 is depicted as installed and wrapped around the outer surface of inner filter 14. Outer filter 16 comprises a suitable filter medium, such as but not limited to, a wire mesh sized and constructed to provide openings sufficiently small to filter particulates contained in fluid flowing through the filter. In an exemplary embodiment, outer filter 16 comprises a woven wire mesh constructed in elongated, relatively narrow sheets. In an exemplary embodiment, outer filter wire mesh is installed from manufactured rolls of material having a length of in excess of 50 meters and having a diameter (width) of approximately 6″ (15.24 cm.). Outer filter 16 is spirally wound around inner filter 14, with an inner surface of outer filter 16 engaging the exterior surface of inner filter 14, and with transverse edges of outer filter 16 abutting each other at seams 30. While outer filter 16 is presented in the embodiment depicted in FIG. 1 as comprising a single layer of a filter medium, in additional embodiments, outer filter 16 may comprise a plurality of layers comprising the same or different filter media. As would be understood by one skilled in the art, the filter medium utilized in the inner filter 14 may be the same as or different than the filter medium utilized in outer filter 16.

For illustration purposes, seams 28 and seams 30 that are not visible are shown with dashed lines. As shown in FIG. 1, outer filter 16 is aligned with inner filter 14 so that outer filter 16 covers seams 28. In the exemplary embodiment, outer filter 16 and inner filter 14 are each of the same width, wherein outer filter 16 installed with continuous seam 28 of inner filter 14 substantially centered between edges of outer filter 16. Accordingly, continuous seam 30 of outer filter 16 extends substantially over the transverse center of filter 14. In other embodiments, one or more additional layers of filter media may be disposed around outer filter 16.

Still referring to FIG. 1, in one embodiment, cover filter 18 comprises a wire wrap filter constructed of ribs 32 and wire 34. In a process that is commercially practiced, cover filter 18 is constructed utilizing specially constructed wire wrap machinery by extending ribs 32 longitudinally along an axis such as axis A-A, spirally wrapping wire 34 around the exterior of ribs 32 and welding wire 34 to ribs 32 at each intersection of wire 34 to a rib 32. Such process is controlled to provide a continuous slot 36 between proximate wire 34 edges. Within limitations, the width of slot 36 opening can be controlled during the manufacturing process.

In an exemplary embodiment of the present invention, axial ends of drain filter 12, inner filter 14, outer filter 16, and cover filter 18 are enclosed by a ring (not shown) attached to each axial end of filter assembly 10. In an exemplary embodiment, the ring is welded at the axial end.

FIG. 2 depicts a view of a drain filter 12 of the present invention constructed independently of pipe 20. Drain filter 12 is sufficiently rigid to be constructed independently of pipe 20 and to support installations of inner filter 14, outer filter 16, and cover filter 18 thereon. In such an embodiment, filter assembly 10 may be constructed for subsequent installation on a pipe section, such as pipe section 20. In an alternative exemplary embodiment, drain filter 12 is constructed on a pipe section, such as pipe section 20.

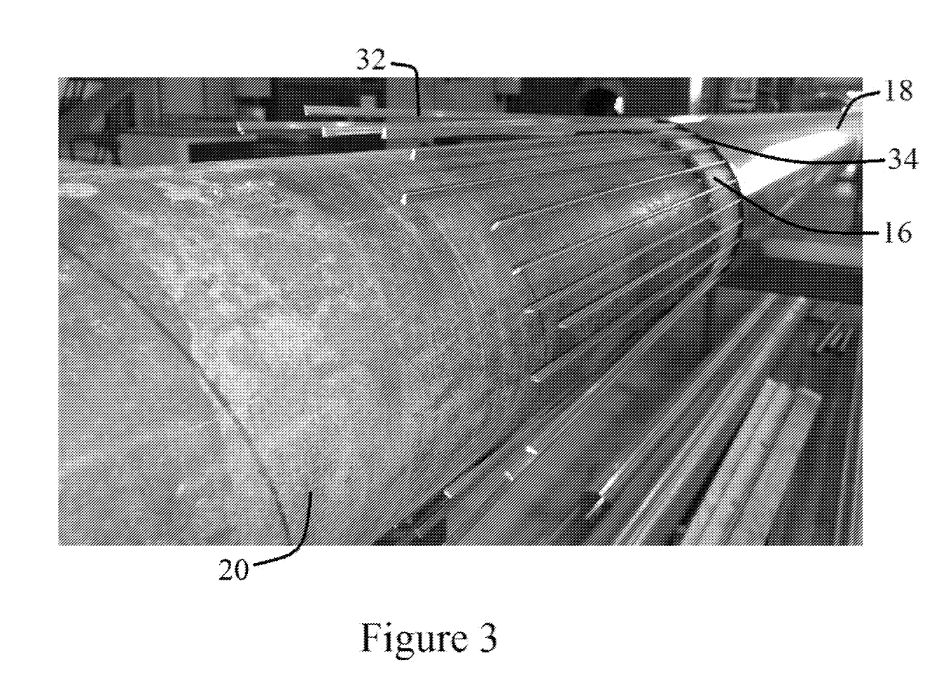

FIG. 3 depicts a perspective view of a filter assembly 10 of an embodiment of the present invention attached to a pipe section 20 prior to trimming of ribs 32 and installation of an end ring on filter assembly 10.

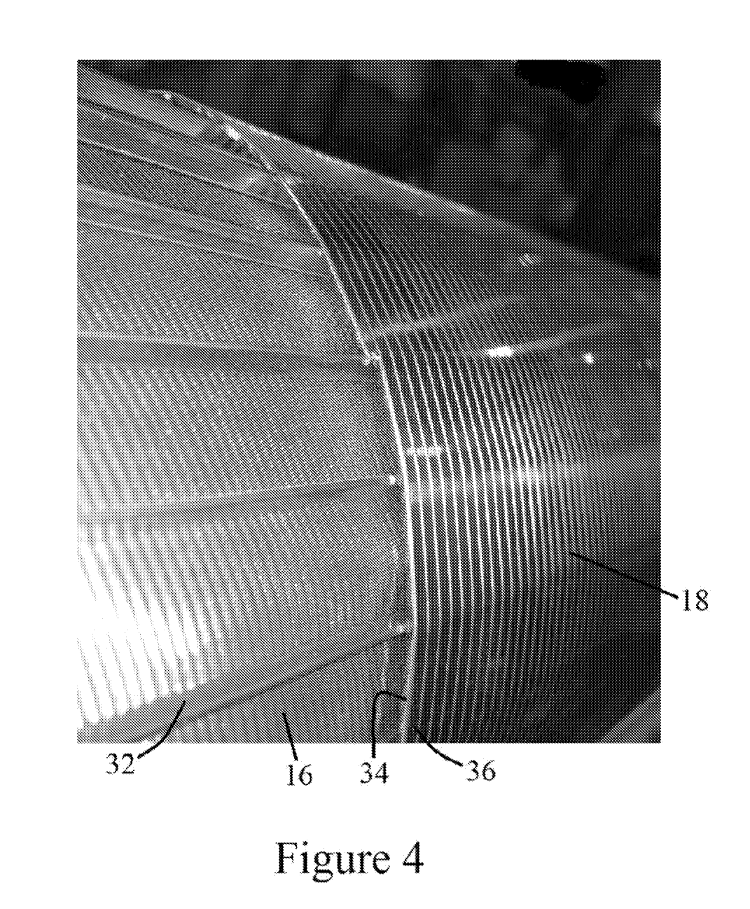

FIG. 4 depicts a detailed view of an embodiment of a cover filter 18 installed on an outer filter 16 with ribs 32, wire 34, and slot 36 shown.

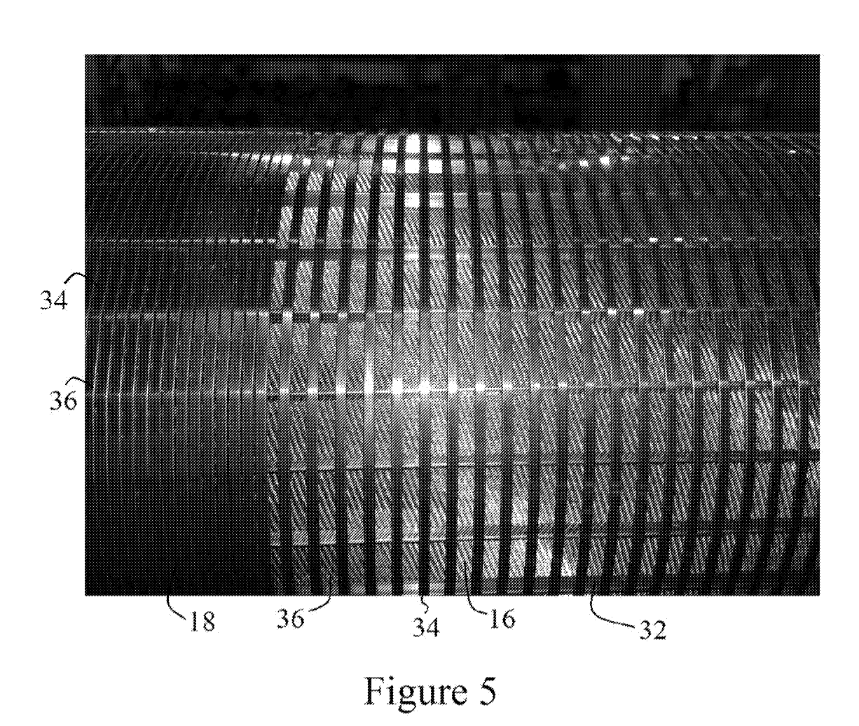

FIG. 5 depicts another detailed view of an embodiment of a cover filter 18 installed on an outer filter 16, with ribs 32, wire 34, and slot 36 shown. As depicted in FIG. 5, the width of slot 36 may be varied as determined appropriate for an application.

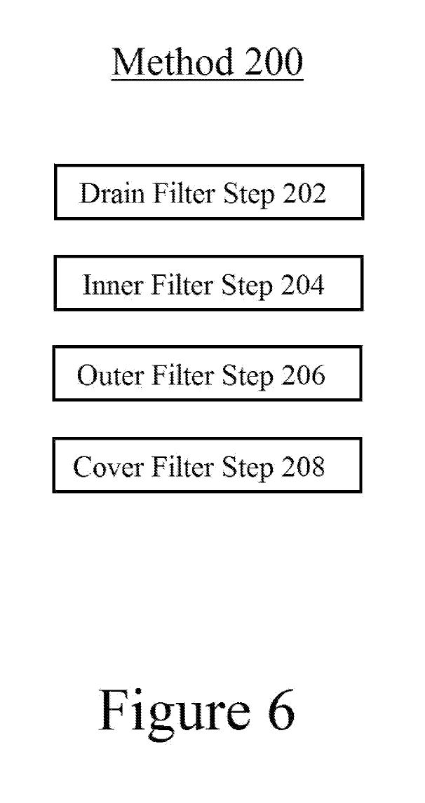

FIG. 6 depicts an embodiment of a method 200 of constructing a filter assembly 10 of an embodiment of the present invention, the method 200 comprising the following steps:

Drain Filter Step 202 comprises constructing a wire wrap drain filter, such as drain filter 12, the wire wrap drain filter having substantially continuous slots, such as slot 26.

Inner Filter Step 204 comprises wrapping an inner filter, such as inner filter 14, spirally around the drain filter constructed in accordance with Step 202, with transverse edges of the inner filter abutting each other, such abutting edges defining an inner filter seam, such as seam 28.

Outer Filter Step 206 comprises wrapping an outer filter, such as outer filter 16, spirally around the inner filter constructed in accordance with Step 204, with transverse edges of the outer filter abutting each other, such abutting edges defining an outer filter seam, such as seam 30, with outer filter media covering the inner filter seam 28, and with the outer filter seam 30 not aligned with seam 28.

Cover Filter Step 208 comprises constructing a wire wrap cover filter, such as cover filter 18, around an outer filter, such as outer filter 16, with ribs, such as ribs 32, engaging an exterior surface of the outer filter, the cover filter having substantially continuous slots, such as slot 36.

While the preferred embodiments of the invention have been described and illustrated, modifications thereof can be made by one skilled in the art without departing from the teachings of the invention. Descriptions of embodiments are exemplary and not limiting. The extent and scope of the invention is set forth in the appended claims and is intended to extend to equivalents thereof. The claims are incorporated into the specification. Disclosure of existing patents, publications and known art are incorporated herein to the extent required to provide reference details and understanding of the disclosure herein set forth.

I claim:

1. A filter assembly for use in down-hole applications, comprising:
a substantially cylindrical drain filter;
a substantially cylindrical inner filter;
a substantially cylindrical outer filter; and
a substantially cylindrical cover filter; wherein:
said inner filter comprises a filter media layer spirally wrapped around said drain filter, whereby adjoining edges of said inner filter media layer abut;
said outer filter comprises a filter media layer spirally wrapped around said inner filter media layer, whereby adjoining edges of said outer filter media layer abut; and
said cover filter is disposed around said outer filter media layer.

2. The filter assembly of claim 1, wherein said abutting edges of said outer filter media layer are offset from said abutting edges of said inner filter media layer.

3. The filter assembly of claim 1, wherein at least one of said drain filter and said cover filter comprises a spirally wound wire supported by a plurality of ribs.

4. The filter assembly of claim 1, comprising at least a portion of a pipe section axially disposed within at least a portion of said drain filter.

5. The filter assembly of claim 1, wherein at least one of said inner filter media and said outer filter media comprises a woven wire mesh.

6. The filter assembly of claim 1, comprising at least one additional filter media layer selected from the group consisting of:
one or more additional inner filter media layers; and
one or more additional outer filter media layers.

7. A filter assembly for use in down-hole applications, comprising:
a substantially cylindrical drain filter;
a substantially cylindrical inner filter;
a substantially cylindrical outer filter; and
a substantially cylindrical cover filter; wherein:
said inner filter comprises a filter media layer spirally wrapped around said drain filter, whereby adjoining edges of said inner filter media layer abut;
said outer filter comprises a filter media layer spirally wrapped around said inner filter media layer, whereby adjoining edges of said outer filter media layer abut;
said abutting edges of said outer filter media layer are offset from said abutting edges of said inner filter media layer; and
said cover filter is disposed around said outer filter media layer.

8. The filter assembly of claim 7, wherein at least one of said drain filter and said cover filter comprises a spirally wound wire supported by a plurality of ribs.

9. The filter assembly of claim 7, comprising at least a portion of a pipe section axially disposed within at least a portion of said drain filter.

10. The filter assembly of claim 7, wherein at least one of said inner filter media and said outer filter media comprises a woven wire mesh.

11. The filter assembly of claim 7, comprising at least one additional filter media layer selected from the group consisting of:
one or more additional inner filter media layers; and
one or more additional outer filter media layers.

12. A method of constructing a filter assembly for use in down-hole applications, comprising:
providing a substantially cylindrical drain filter;
spirally wrapping an inner filter media layer around said drain filter, whereby adjoining edges of said inner filter media layer abut;
spirally wrapping an outer filter media layer around said inner filter media layer, whereby adjoining edges of said outer filter media layer abut; and
providing a substantially cylindrical cover filter around said outer filter media layer.

13. The method of claim 12, wherein said abutting edges of said outer filter media layer are offset from said abutting edges of said inner filter media layer.

14. The method of claim 12, wherein at least one of said drain filter and said cover filter comprises a spirally wound wire supported by a plurality of ribs.

15. The method of claim 12, comprising providing at least a portion of a pipe section within at least a portion of said drain filter.

16. The method of claim 12, wherein at least one of said inner filter media and said outer filter media comprises a woven wire mesh.

17. The method of claim 12, comprising at least one step selected from the group consisting of:
spirally wrapping one or more additional inner filter media layers around said inner filter media layer; and
spirally wrapping one or more additional outer filter media layers around said outer filter media layer.
